(19) United States
(12) Patent Application Publication
(10) Pub. No.: US 2011/0161611 A1
(43) Pub. Date: Jun. 30, 2011

(54) METHOD FOR CONTROLLING SEMICONDUCTOR STORAGE SYSTEM CONFIGURED TO MANAGE DUAL MEMORY AREA

(75) Inventors: Young Kyun SHIN, Gyeonggi-do (KR); Dae Hee YI, Seoul (KR); Jong Gah KIM, Seoul (KR)

(73) Assignees: HYNIX SEMICONDUCTOR INC., Gyeonggi-do (KR); PAXDISK CO., LTD., Seoul (KR)

(21) Appl. No.: 12/833,100

(22) Filed: Jul. 9, 2010

(30) Foreign Application Priority Data
Dec. 24, 2009 (KR) 10-2009-0130781

(51) Int. Cl. G06F 12/00

(52) U.S. Cl. 711/163; 711/154; 711/E12.001

(57) ABSTRACT

A method for controlling a semiconductor storage system configured to manage dual memory areas for protecting the system against abrupt and abnormal power disruptions is presented. The semiconductor storage systems has a first physical area and a second physical area, in which first data having a first logical block address are stored in the first physical area. The method includes providing a write command so that the first data is updated to second data. The method also includes writing the second data in a second physical area in response to the write command. When writing the second data in the second physical area, a corresponding invalid logical address is allocated to the second physical area.

### CROSS-REFERENCES TO RELATED APPLICATION

The present application claims priority under 35 U.S.C. §119(a) to Korean application No. 10-2009-0130781, filed on Dec. 24, 2009, in the Korean Intellectual Property Office, which is incorporated herein by reference in its entirety as set forth in full.

### BACKGROUND

1. Technical Field

The present invention relates to a method for controlling a semiconductor storage system, and more particularly, to a method for controlling a semiconductor storage system configured to manage a dual memory area.

2. Related Art

In general, a hard disk is widely used as an auxiliary storage apparatus of a central processing unit (CPU) or a system. The hard disk includes a metal plate (or disk), a spindle motor for rotating the metal plate, a head for seeking a sector on which data is recorded, and an actuator for actuating the head. When the metal plate rotates by means of driving of the spindle motor, the head searches sectors of the metal plate, and can read desired data from the corresponding sector. The physical structure of the hard disk and the physical data search method may cause a defect. For example, evaporation of lubricant on the spindle motor during high-speed rotation may cause a defect of the machine itself. In addition, an impact caused by physical operations involved with high-speed rotation may result in a scratch. Since it takes a predetermined time (i.e. latency) for the head to search the sectors during rotation and to read data from the corresponding sector, the read time may be lengthened.

Therefore, it is the current trend to use a flash solid state drive (SSD) in place of the hard disk. Particularly, an SSD equipped with a NAND flash device has no physical driving movements, and is accordingly more robust against mechanical impact damage. Furthermore, due to the operation characteristics of the NAND flash device, data searching is conducted at a high speed.

During booting of a semiconductor storage system, such as the SSD, a necessary operating system (OS), an application program, etc. are loaded to set the operator's working environment. Even during the booting, the SSD tries a write operation when a write command is applied.

FIG. 1 is a graph showing read and write situations of an SSD during booting by using booting optimization software.

It is clear from FIG. 1 that a large number of read and write commands are executed even during booting. If the system is powered off abnormally while a write operation is being conducted in response to a write command together with booting, the OS or some programs and files may be damaged. Therefore, there exists a need to protect the system disk even under an abnormal power environment during booting.

### SUMMARY

In one embodiment of the present invention, a method for controlling a semiconductor storage system having a first physical area, in which first data having a first logical block address is stored, includes the steps of: providing a write command so that the first data is updated to second data; and writing the second data in a second physical area in response to the write command, wherein when writing the second data in the second physical area, a corresponding invalid logical address is allocated to the second physical area.

In another embodiment of a semiconductor storage system comprises a first storage area; and a second storage area, wherein when updating a first data stored in the first storage area to a second data in response to a write command, the first data is still stored in the first storage area which a logical address is assigned and the second data is stored in the second storage area which a invalid logical address is assigned.

### BRIEF DESCRIPTION OF THE DRAWINGS

Features, aspects, and embodiments are described in conjunction with the attached drawings, in which:

FIG. 1 is a graph illustrating read and write operations which generally occur during system booting;

FIG. 2 is a block diagram of a semiconductor storage system according to one embodiment;

FIG. 3 is a block diagram illustrating a data transmission relationship based on FIG. 2;

FIG. 4 is a block diagram conceptually illustrating the structure of a file system based on FIG. 2;

FIGS. 5 and 6 illustrate management tables regarding first and second areas;

FIG. 7 is a conceptual diagram illustrating write and read processes in terms of lists of commands in the case of normal and protect modes, respectively; and

FIG. 8 is a flowchart illustrating a method for controlling a semiconductor storage system according to one embodiment.

### DETAILED DESCRIPTION

Hereinafter, a semiconductor storage system and a method for controlling the same, according to the present invention, will be described below with reference to block diagrams or flowcharts shown in the accompanying drawings through preferred embodiments.

Each block diagram may indicate a part of a module, a segment, or a code, which includes at least one executable instruction for executing a specified logical function(s). It is also to be noted that, in a number of alternative execution examples, functions referred to in the blocks can occur out of order. For example, two blocks shown one after the other may be executed substantially at the same time, or the blocks may sometimes be executed in the opposite order according to corresponding functions.

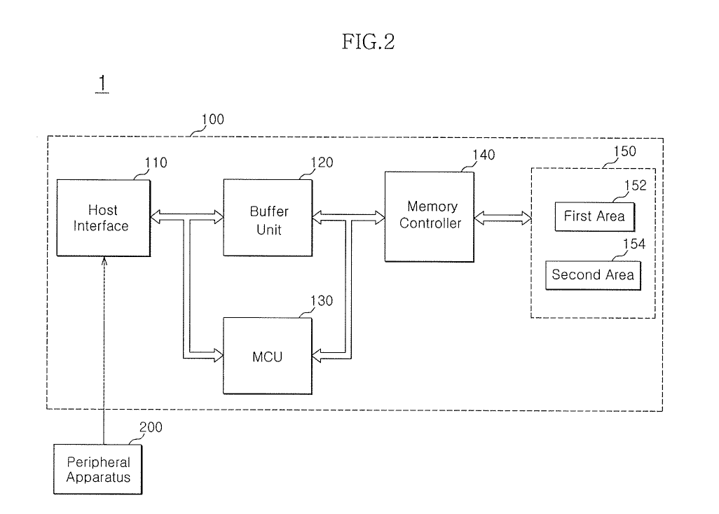

A semiconductor storage system according to one embodiment will be described with reference to FIG. 2.

FIG. 2 is a block diagram of a semiconductor storage system 1 according to one embodiment. It will be assumed in the following description that the semiconductor storage system 1 is a system using a NAND flash memory.

Referring to FIG. 2, the semiconductor storage system 1 includes an SSD 100 and a peripheral apparatus 200.

The SSD 100 includes a host interface 110, a buffer unit 120, an MCU 130, a memory controller 140, and a memory area 150.

The peripheral apparatus 200 is configured to control the host interface 110, and can selectively control the SSD 100 in a normal or protect mode.

The host interface 110 is electrically connected with the buffer unit 120. The host interface 110 is configured to transmit/receive a control command, an address signal, and a data signal between an external host (not shown) and the buffer unit 120. The type of interface between the host interface 110 and the external host (not shown) may be one of, but is not limited to, serial advanced technology attachment (SATA), parallel advanced technology attachment (PATA), SCSI, Express Card, and PCI-Express.

The buffer unit 120 is configured to buffer output signals from the host interface 110 or temporarily store information regarding the mapping between logical addresses and physical addresses, information regarding block allocation in the memory area, the number of deletion of blocks, and data received from the outside. The buffer unit 120 may be a buffer using a static random access memory (SRAM) or a dynamic random access memory (DRAM).

The micro control unit (MCU) 130 is configured to transmit/receive a control command, an address signal, a data signal, etc. with the host interface 110 or control the memory controller 140 by means of these signals.

Like a conventional controller, the memory controller 140 receives input data and a write command from the host interface 110, and conducts control so that the input data can be written in the memory area 150. Similarly, when receiving a read command from the host interface 110, the memory controller 140 conducts control so that data is read from the memory area 150 and outputted to the outside.

The memory controller 140 according to one embodiment uses a first area 152 when reading and writing in a normal mode. In a protect mode, however, the first area 152 is used to read existing data, and a second area 154 is used for updating. The second area 154 is completely reset the next time the system is powered on. As such, the memory controller 140 according to one embodiment can either continuously update and manage the content of the SSD 100 as usual or temporarily use the SSD 100 and then restore it to a system condition before update. The memory controller 140 will be described later in more detail with reference to the drawings.

The memory area 150 according to one embodiment includes a first area 152 and a second area 154. The first and second areas 152 and 154 refer to first and second physical areas, respectively.

The first area 152 is controlled by the memory controller 140 so as to conduct data write, delete, and read operations. The first area 152 can include a NAND flash memory cell. The first area 152 is the object of normal logical-physical address mapping table management by the memory controller 140. In other words, data in the first area 152 corresponds to a memory area normally managed by a logical-physical address mapping table.

The second area 154 is temporarily or conditionally managed by the memory controller 140. Under a predetermined condition, data write, delete, and read operations are conducted in the second area 154 as in the first area 152. However, the second area 154 is completely reset the next time the system is powered on after power-off, i.e. at the time of rebooting. The second area 154 is managed by an arbitrary logical-physical address mapping table. However, the mapping table is not stored permanently, but is only used temporarily. The mapping table for managing the second area 154 may use invalid logical addresses which are not used as addresses of the first area 152. Specifically, the arbitrary mapping table may use virtual logical addresses. Alternatively, arbitrary identifiers or arbitrary code values may be used for management. In other words, the second area 154 refers to an arbitrary area which is not assigned addresses of a valid mapping table, but which is used like a normal memory area only temporarily. Such assignment of virtual logical addresses, arbitrary identifiers, or arbitrary code values to the second area 154 is for the purpose of enabling the memory controller 140 to separately manage a temporary area corresponding to the logical addresses.

Although it has been assumed that the first and second areas 152 and 154 have substantially the same size, the size is not limited thereto. The second area 154 also includes a NAND memory cell as in the case of the first area 152.

Selective control of the normal and protect modes by the peripheral apparatus 200 may be based on use of a physically implemented switch, provision of a switch command, or use of a soft flag. However, the type of control by the peripheral apparatus 200 is not limited specifically as long as it has the function of enabling selective switching between the normal and protect modes.

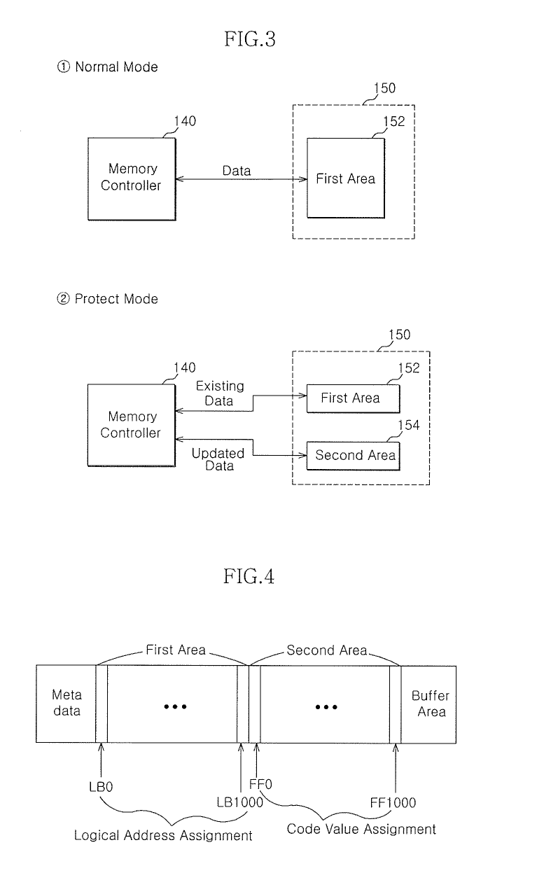

FIG. 3 is a block diagram illustrating the data transmission relationship between the memory controller 140 and the memory area 150 based on FIG. 2.

Referring to FIG. 3, when the peripheral apparatus 200 (FIG. 2) provides a normal mode environment \textcircled{1}, the memory controller 140 uses the first area 152. For example, when writing, data from the buffer unit 120 is written in the first area 152. When reading, data in the first area 152 is accessed and read. As in a conventional case, update and merger of data also occur in the first area 152.

When the peripheral apparatus 200 (FIG. 2) provides a protect mode environment \textcircled{2}, the memory controller 140 can use both the first and second areas 152 and 154. For example, when reading existing data, the memory controller 140 uses the first area 152. However, when the memory controller 140 newly writes, updated data is written in the second area 154. When reading the updated data, data in the second area 154 is accessed and read. Although temporarily, update and merger of data may also occur in the second area 154. However, data is only stored temporarily in the second area 154. In other words, existing data is stored in the first area 152, and when reading the existing data, the first area 152 is used. However, when newly writing updated data or reading the updated data, the second area 154 is used so that existing data in the first area 152 can be protected.

That is, it is only during the current session after entering the protect mode that the memory controller 140 temporarily refers to the second area 154 for a write or read operation. Next time the system is powered on, the memory controller 140 resets the second area 154 and controls it so that it is not referred to again. In other words, even if the system is powered on the next time in the protect mode again, the previous second area 154 is reset, and data is newly written or read in the second area 154. As such, the second area 154 is no longer used to refer to previous data. Consequently, it is not necessary to manage and maintain a separate mapping table for the second area 154.

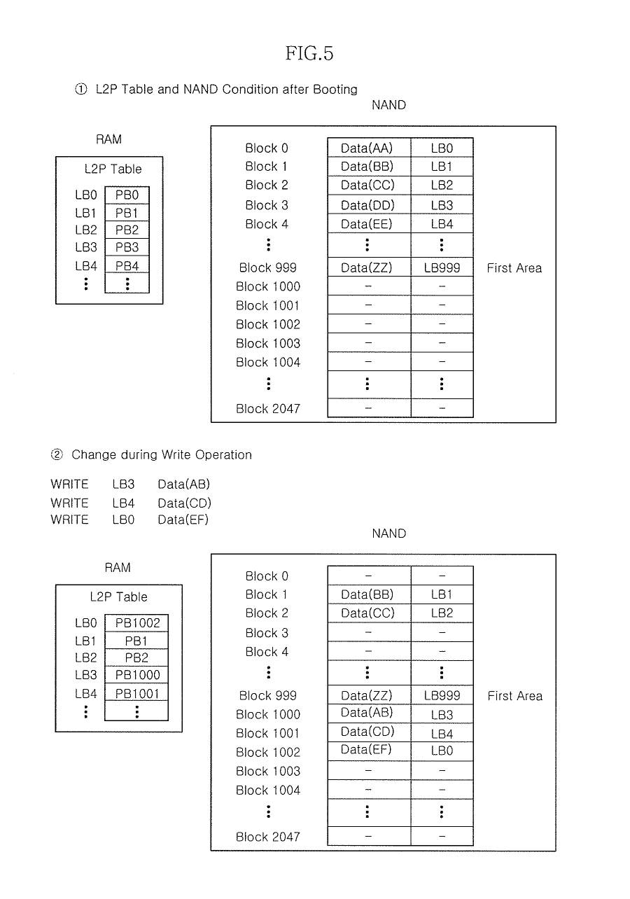

FIG. 4 is a block diagram conceptually illustrating the structure of a file system according to one embodiment.

Referring to FIG. 4, the file system includes a metadata area, a first area 152 (FIG. 2), a second area 154 (FIG. 2), and a data area for the buffer unit 120 (FIG. 2).

The first area 152 (FIG. 2) refers to an area assigned logical addresses. It will be assumed for convenience in explanation that the first area 152 (FIG. 2) is assigned logical addresses LB0 to LB1000.

The second area 154 (FIG. 2) refers to an area assigned no valid logical addresses. It will be assumed for convenience in explanation that the second area 154 (FIG. 2) is assigned code values FF0 to FF1000. Those skilled in the art can understand that this assumption is not limiting, and for example, a virtual logical address LB3000 may be assigned.

As such, according to one embodiment, the second area 154 (FIG. 2) is used as a temporary area and is not referred to after power-off.

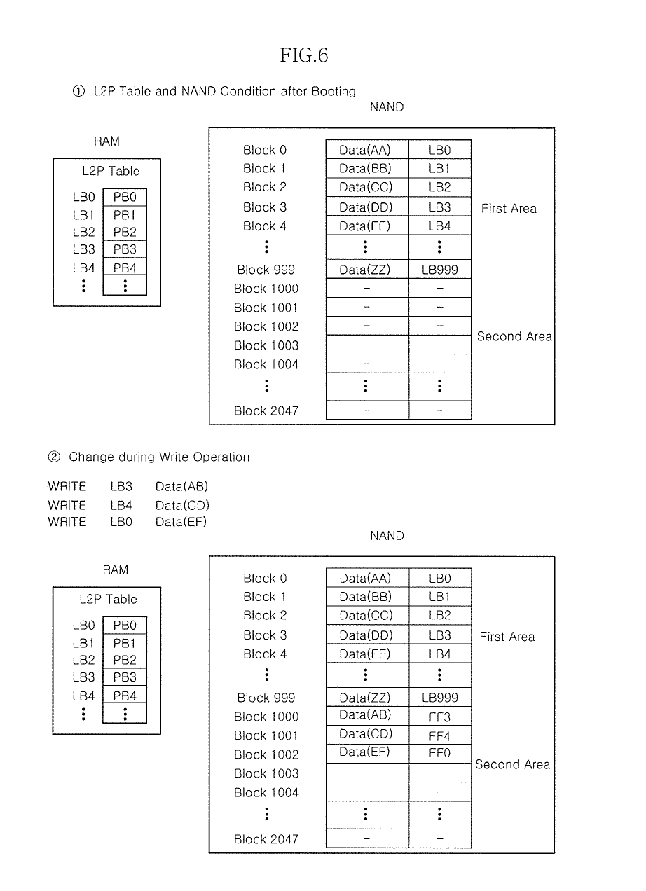

FIG. 5 shows a mapping table for the first area 152 which is assigned logical addresses.

Referring to FIG. 5, the relationship between logical addresses and physical addresses of the first area 152 (FIG. 2) is shown in part \textcircled{1}. Logical address LB0 is assigned an area corresponding to physical address PB0 of the first area 152 (FIG. 2). Similarly, logical address LB1 is assigned an area corresponding to physical address PB1 of the first area 152 (FIG. 2). For example, data is first stored at PB0 to PB999, and the area from PB1000 to PB2047 is a free area.

Part of \textcircled{2} of FIG. 5 shows a case in which new data needs to be updated with regard to logical addresses LB3, LB4, and LB0.

To be specific, existing data AA at logical address LB3 is updated to new data AB; existing data CC at logical address LB4 is updated to new data CD; and existing data EE at logical address LB0 is updated to new data EF.

The updated data AB at logical address LB3 of the first area 152 is stored at new physical address PB1000; the updated data CD at logical address LB4 is stored at new physical address PB1001; and the updated data EF at logical address LB0 is stored at new physical address PB1002. This relationship is stored in the mapping table. Data at existing physical addresses PB0, PB3, and PB 4 are deleted.

As such, the memory controller 140 (FIG. 2) manages and maintains the mapping table to assign updated data new physical addresses and maintain the updated data stored at the new physical addresses.

FIG. 6 shows a mapping table for the second area 154, which is assigned code values.

Referring to FIG. 6, part \textcircled{1} illustrates a case of entering a protect mode while data in the first area 152 remains in the previous condition (i.e. the data is not updated). The area corresponding to physical addresses PB1000 to PB2047 can be used temporarily as the second area 154.

For example, the area from PB0 to PB999 needs to be protected always, and the area from PB1000 to PB2047 can be used either as a first area 152 extended for update in a normal mode or as a second area 154 in a protect mode.

After entering the protect mode, data at logical addresses LB3, LB4, and LB0 is updated as shown in part \textcircled{2}.

Specifically, existing data AA at logical address LB3 is updated to new data AB; existing data CC at logical address LB4 is updated to new data CD; and existing data EE at logical address LB0 is updated to new data EF.

The updated data AB stored at new physical address PB1000 is assigned, for example, arbitrary code value FF3 instead of logical address LB3; the updated data CD stored at new physical address PB1001 is assigned arbitrary code value FF4; and the updated data EF stored at new physical address PB1002 is assigned arbitrary code value FF0. These code values are identifiers that are referred to when reading updated data. According to one embodiment, data stored at existing physical addresses PB0, PB3, and PB4 of the first area 152 is not deleted, but is retained intact. That is, data is updated in the second area 154, but data already stored in the first area 152 and related logical addresses are retained intact.

The updated data in the second area 154 is assigned arbitrary code values, and updated data stored at new physical addresses is used temporarily.

Those skilled in the art can understand from the above description that, according to one embodiment, the memory area 150 (FIG. 2) includes a dual area, but it is only with regard to the first region 152 (FIG. 2) that a logical-physical address mapping table is maintained and managed. The second area 154 (FIG. 2) is assigned arbitrary code values, temporarily managed, and reset after a power-off event.

Furthermore, according to one embodiment, control can be conducted in such a manner that, according to whether the mode is switched or not, either updated data or data before update is used.

This feature can be utilized more actively to conduct control in such a manner that read and write operations occur only in the temporary second area 154 (FIG. 2) to prevent important OS, application programs, etc. from being damaged by an unexpected power environment during booting. After a predetermined period of time, i.e., after booting is completed, the first area 152 (FIG. 2) can be used.

Alternatively, each operator can apply mode switching between the protect and normal modes, or use the protect mode while conducting a specific operation only.

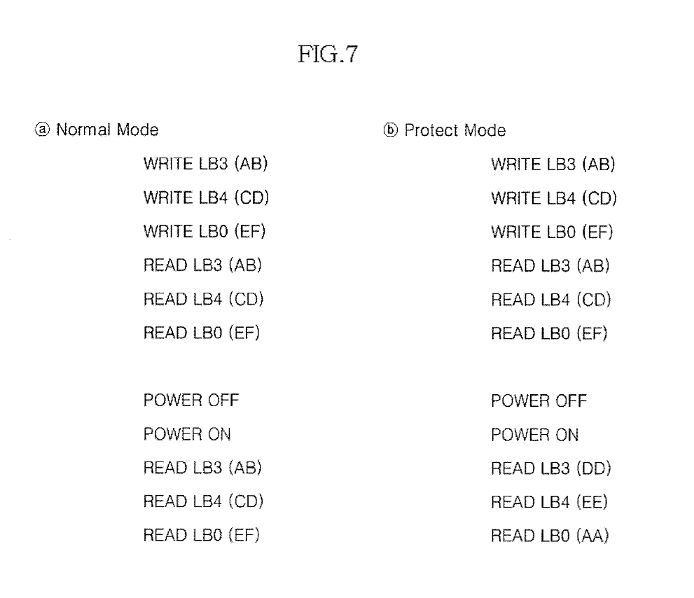

FIG. 7 illustrates write and read processes in terms of lists of commands in the case of normal and protect modes, respectively.

In the case of normal mode \textcircled{a}, when new data is written at logical addresses LB3, LB4, and LB0, respectively, what is then read from respective logical addresses LB3, LB4, and LB0 is updated data AB, CD, and EF.

If the system is powered off abruptly and abnormally, and then powered on again, what will be read from logical addresses LB3, LB4, and LB0 is updated data AB, CD, and EF. This is the same as in a conventional SSD read process.

As mentioned above, if a conventional system is abnormally powered off while such write and read operations frequency occur during booting, the OS and some programs may be damaged.

However, in the case of protect mode \textcircled{b}, when new data is written at logical addresses LB3, LB4, and LB0, respectively, what is then read from respective logical addresses LB3, LB4, and LB0 is updated data AB, CD, and EF.

Thereafter, if the system is powered off abruptly and abnormally and then powered on again, the memory controller 140 (FIG. 2) resets the second area 154 completely and maintain the existing data region, i.e. first data 152, intact.

Therefore, what will be read from logical addresses LB3, LB4, LB0 is not updated data AB, CD, and EF, but existing data DD, EE, and AA stored in the first area 152.

That is, when entering the protect mode, data is only processed temporarily so as to automatically return to a condition before change at the same time the system restarts. As a result, the OS and application programs are protected intact from any damage that may occur during booting. As widely known in the art, the OS and application programs may be attacked by any number of various sources such as viruses, undesired or illegal software, malicious codes, etc. By using the above-mentioned protect mode, it is possible to always maintain a clean booting environment. This improves the system reliability.

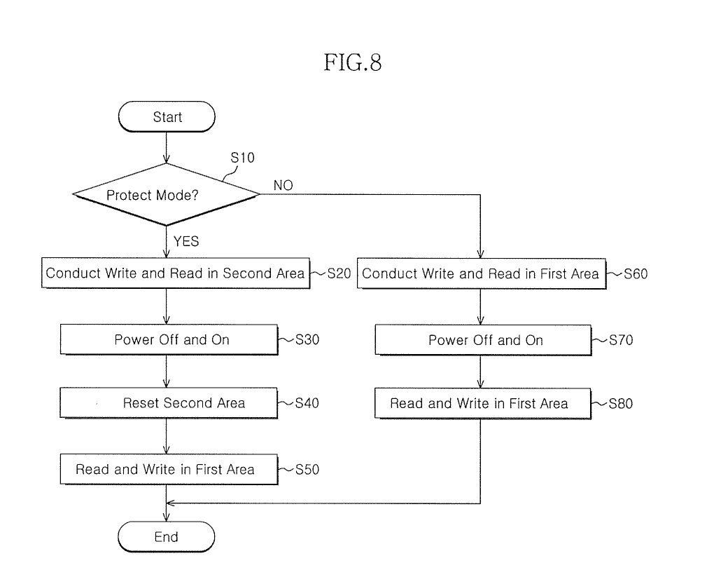

FIG. 8 is a flowchart illustrating the operation of a semiconductor storage system according to one embodiment.

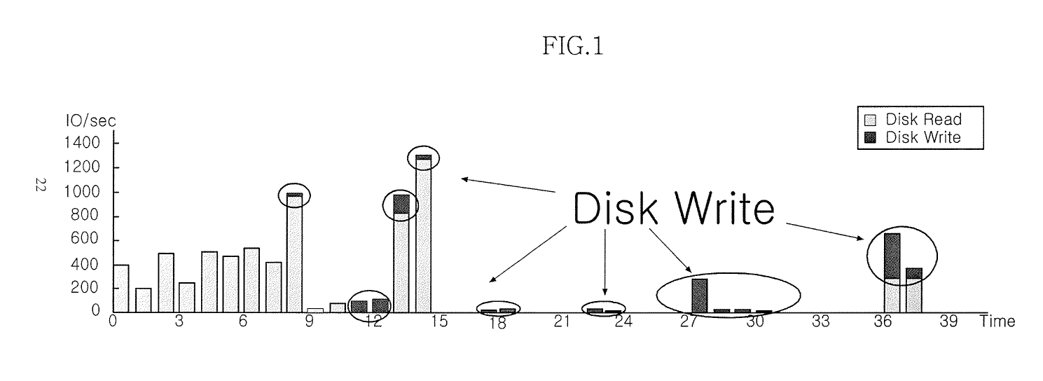

The operation of the semiconductor storage system will be described with reference to FIGS. 1 through 8.

The system first determines if a protect mode has been selected (S10).

When the external peripheral apparatus 200 has determined to enter the protect mode (YES), a write operation is conducted in the second area 154 (S20).

A write operation occurring during booting is conducted in the second area 154, which is a temporary area. Subsequently, for read and write operations occurring during the protect mode, the second area 154 (temporary area) is used.

When reading existing data, the first area 152 is used.

If the system is powered off abruptly and abnormally and then restarted (S30), the memory controller 140 resets the second area 154.

The memory controller 140 conducts control so that read and write operations are conducted by using the first area 152 (S50).

Meanwhile, if entry into a normal mode has been determined (NO) as a result of determining whether the protect mode has been selected (S10), the first area 152 is used to conduct read and write operations as usual (S60).

If the system is powered off abruptly and abnormally and then restarted (S70), read and write operations are conducted by using the first area 152.

When the first area 152 is used, all contents updated by frequent write and read operations can be continuously reflected even later. When the second area 154 is used, however, write and read operations are conducted temporarily, and the finally stored first area 152, information regarding the first area 152, OS, application programs, etc. can be protected and maintained in the same condition as they have been finally stored.

As such, by switching and using a suitable mode according to usage, the booting environment can always be maintained constantly, and the system can be safely protected from unauthorized users or illegal software. As a result, the system reliability is improved.

According to one embodiment, when entering a predetermined mode, e.g. protect mode, data read, write, and update operations are conducted in a temporary area. If the system is powered off and then restarted, the temporary area is completely reset to return to a system condition before update has occurred in the temporary area.

While certain embodiments have been described above, it will be understood to those skilled in the art that the embodiments described are by way of example only. Accordingly, the method for controlling a semiconductor storage system configured to manage a dual memory area described herein should not be limited based on the described embodiments. Rather, the method for controlling a semiconductor storage system configured to manage a dual memory area described herein should only be limited in light of the claims that follow when taken in conjunction with the above description and accompanying drawings.

What is claimed is:

1. A method for controlling a semiconductor storage system having a first physical area, in which first data having a first logical block address is stored, the method comprising:
providing a write command so that the first data is updated to second data; and
writing the second data in a second physical area in response to the write command, wherein
when writing the second data in the second physical area, a corresponding invalid logical address is allocated to the second physical area.

2. The method according to claim 1, wherein the invalid logical address is a virtual logical address which is not allocated to the first physical area.

3. The method according to claim 1, wherein the invalid logical address can be replaced with an arbitrary code value.

4. The method according to claim 1, wherein the invalid logical address is irrelevant to addresses for updating and merging data in the first physical area.

5. The method according to claim 1, wherein the second physical area is configured to be reset at a power-on time.

6. A semiconductor storage system comprising:
a memory controller configured to use data in a first area during a normal mode, and configured to use data in the first area and in a second area during a protect mode in which the second area is separate from the first area.

7. The semiconductor storage system according to claim 6, wherein, when in the normal mode, the data in the first area is read and written.

8. The semiconductor storage system according to claim 6, wherein, when in the protect mode, existing data is read from the is first area, and updated data is written in the second area.

9. A semiconductor storage system configured to process existing data by using a first area and process updated data by using a second area separate from the first area.

10. The semiconductor storage system according to claim 9, wherein selective use of the first and second areas is determined by a mode of a peripheral apparatus.

11. The semiconductor storage system according to claim 9, wherein processing of the data is conducted by a memory controller.

12. The semiconductor storage system according to claim 10, wherein a normal mode or a protect mode is determined by the peripheral apparatus,
such that when in the normal mode, data in the first area is used, and
such that when in the protect mode, existing data is read from the first area, and updated data is written in the second area.

13. A semiconductor storage system comprising:
a first storage area; and
a second storage area,
wherein when updating a first data stored in the first storage area to a second data in response to a write command,
the first data is still stored in the first storage area which a logical address is assigned and the second data is stored in the second storage area which a invalid logical address is assigned.

14. The semiconductor storage system according to claim 13,
wherein the invalid logical address is a virtual logical address which is not allocated to the first storage area.
